(19) United States
(12) Patent Application Publication
(10) Pub. No.: US 2024/0227385 A1
(43) Pub. Date: Jul. 11, 2024

(54) ROTARY PRINTING PRESS WITH CLEANING UNIT AND METHOD FOR CLEANING A SUBSTRATE

(71) Applicant: BOBST BIELEFELD GMBH, Bielefeld (DE)

(72) Inventors: Frank RUDOLPH, Versmold (DE); Marco CARRARA, Castelnuovo del Garda (VR) (IT)

(73) Assignee: BOBST BIELEFELD GMBH, Bielefeld (DE)

(21) Appl. No.: 18/404,011

(22) Filed: Jan. 4, 2024

(30) Foreign Application Priority Data
Jan. 10, 2023 (EP) 23150944.9

(51) Int. Cl. B41F 23/00

(52) U.S. Cl. CPC B41F 23/002; B41P 2235/23

(57) ABSTRACT

The invention relates to a rotary printing press (10) for printing substrates (18), comprising a substrate transport system (12) which comprises a winder station (14) and an unwinder station (16) configured to transport a substrate (18) during a printing process along a printing handling path (19) from the unwinder station (16) to the winder station (14), wherein the rotary printing press (10) further comprises at least one cleaning unit (46) which is assigned to the printing handling path (19) and adapted to remove ink from the front side of the substrate (18). Further, the invention relates to a method for cleaning a substrate (18).

The invention relates to a rotary printing press and a method for cleaning a substrate in a rotary printing press.

A rotary printing press is a device which utilizes a flexible relief plate for printing images onto various types of substrates e.g., carton, paper, plastic, metallic foil and cellophane.

In a typical printing process, a sheet of substrate (web) is moved by a substrate transport system along a printing handling path from an unwinder station to a winder station. During the transport between said stations, an ink is applied to a front side of the substrate by at least one printing unit.

For achieving a high quality printing on the substrate, certain parameters have to be adjusted prior to the aforementioned printing process. This is typically performed during an adjustment phase in the beginning of the printing process.

In order to adjust the settings of the machine, a test print is performed. Such a test print is typically performed on regular substrate material. However, it is often necessary to carry out several test prints thereby printing images with different settings onto the substrate until the optimal settings for the respective printing job have been found. One drawback of this practice is that a considerable amount of waste is produced. For example, usually 600 meter or more of substrate sheet are produced per test print.

Moreover, not only the amount of waste being produced is an issue. The waste produced due to the test print have to be removed from the machine which also requires personnel and time. As a result, the productivity of the rotary printing press is reduced, especially when the actual printing process to be performed is relatively short.

There are several attempts in the prior art to increase the productivity of a printing press by improving the adjustment phase prior to the printing process. One possible way is proposed by EP 1 916 102 B1 which discloses a method for adjusting a roller in a rotary printing press by electronic means. This system is also known as a smart GPS system.

Another system for automatically inspecting the printed images and correspondingly adjusting the settings is presented in the EP 1 249 356 B1. In detail, visual inspection of the printed images with the human eye is replaced by electronic image detecting and electronic feedback control.

However, methods and devices disclosed in the prior art are solely directed to the adjustment of parameters prior to the printing process. There is still a demand for further increasing the productivity of a rotary printing process by other means.

Thus, it is an object of the present invention to provide a rotary printing press with improved productivity.

This objective is achieved by a rotary printing press for printing substrates, comprising a substrate transport system, the substrate transport system comprising a winder station and an unwinder station configured to transport a substrate during the printing process along a printing handling path from the unwinder station to the winder station. Further, at least one printing unit is arranged between the winder station and the unwinder station, the at least one printing unit is configured to apply an ink to a front side of the substrate being moved through the printing unit along the printing handling path. A control unit which is connected to the substrate transport system is configured to control a speed of the substrate which is moved through the substrate transport system along the printing handling path. The rotary printing press further comprises at least one cleaning unit which is assigned to the printing handling path and which is adapted to remove ink from the front side of the substrate.

The principal idea of the invention is to increase the productivity of a rotary printing press by recycling the printed substrate which is produced during the adjustment phase. This is achieved in a simple manner by removing the ink from the substrate using the cleaning unit. As a result, the substrate can be recovered and re-printed again during the subsequent printing job. Thus, the production of waste is effectively prevented. Following this line of thought, also the ejection of the produced waste from the machine is prevented which is often a time-consuming step in the adjustment phase.

The cleaning of the substrate can be carried out in a simple manner by providing at least one cleaning unit along the printing handling path along which the substrate is anyway transported. Thus, the cleaning unit can be installed in a space-saving manner with marginal effort at the rotary printing press. Furthermore, the cleaning unit may also be installed on existing machines.

According to a first aspect of the invention, the at least one cleaning unit comprises one or more cleaning elements selected from the group consisting of brushes, brush rollers and mitter curtains and combinations thereof.

The above listed cleaning elements enable the cleaning unit to remove ink from the front side of the substrate in an abrasive manner. As such, the cleaning elements can brush or wipe over the surface of the substrate in order to remove the ink. This allows a time-efficient as well as cost-efficient way of cleaning the substrates.

According to another embodiment of the invention, the rotary printing press further comprises a detergent dispenser unit, the detergent dispenser unit comprising at least one detergent reservoir, said detergent reservoir including at least one detergent, and at least one nozzle. The detergent reservoir and the nozzle are fluidly coupled to each other, wherein the detergent reservoir is configured to supply the detergent to the nozzle. Further, the nozzle is adapted to apply detergent onto the front side of the substrate and/or the cleaning element.

With other words, the removal of the ink from the front side of the substrate by abrasive means is further supported by adding a detergent to the substrate and/or the cleaning element. The provision of a detergent allows a more efficient and effective cleaning of the substrate by the cleaning element.

Under the term “detergent” a solution and/or dispersion of chemical compounds is to be understood, wherein the detergent has cleansing properties enabling a removal of ink from the surface of the substrate. Preferred embodiments of the detergents are described down below in more detail.

Another aspect of the invention is that the detergent dispenser unit further comprises a heating unit which is assigned to the at least one detergent reservoir and which is adapted to heat the detergent to a predetermined temperature.

A detergent which is heated to a certain temperature allows a more sufficient and efficient cleaning of the substrate. Compared to cold detergents e.g., temperatures below 25° C., warm detergents are found to be more efficient in removing ink.

Preferably, the predetermined temperature is at least room temperature being defined in the following as 25° C. More preferably, the predetermined temperature is above 25° C. Even more preferably, the predetermined temperature is adapted to heat the detergent to at least 35° C.

According to another aspect of the invention, the detergent dispenser unit comprises at least two detergent reservoirs, each reservoir includes at least one detergent which is different from at least one detergent of the other detergent reservoir.

Providing different detergents for the cleaning unit allows the removal of different types of inks from the substrate. For example, each reservoir may be filled with a detergent which is specified to remove a certain type of ink e.g., water-based or organic-based inks.

According to another aspect of the invention, the at least one detergent may comprise an organic and/or an aqueous solution.

Preferably, the organic solution may comprise at least one organic solvent selected from the group consisting of alcohol, ketone, acetate, ether, aromatic hydrocarbon, saturated hydrocarbon, unsaturated hydrocarbon, hydrocarbon functionalized with at least one heteroatom and a combination thereof.

Examples are, but not limited thereto, ethanol, butanol, acetone, isopropanol, methyl acetate, ethyl acetate, hexane, petrol ether, toluene, turpentine and tetrachloroethylene.

More preferably, the at least one detergent may comprise a mixture of an organic and an aqueous solution.

For example, the at least one detergent may comprise a mixture of ethanol and water.

In particular, a detergent based on an aqueous solution may be used to remove water-soluble inks from the substrate, whereas a detergent based on an organic solution may be used to remove organic-soluble inks. Thus, each ink may be removed with the suitable type of detergent, each type of detergent may be stored in a separate detergent reservoir.

In another aspect of the invention, the at least one detergent further comprises at least one cleaning agent, wherein the at least one cleaning agent is selected from the group consisting of base, acid, surfactant, enzyme, zeolite and additive and a combination thereof.

Example for the base are, but not limited thereto, sodium hydroxide, potassium hydroxide, calcium hydroxide and magnesium hydroxide.

Example for the acid are, but not limited thereto, acetic acid, citric acid, hydrochloric acid and phosphoric acid.

Example for the surfactants are, but not limited thereto, anionic surfactants, cationic head groups surfactants, zwitterionic surfactants and non-ionic surfactants. Suitable surfactants may be ammonium lauryl sulfate, sodium lauryl sulfate, docusate, sodium laureth sulfate, sodium lauroyl sarcosinate, cetrimonium bromide, cetylpyridinium chloride, phosphatidylserine, phosphatidylethanolamine, phosphatidylcholine, octaethylene glycol monododecyl ether and sodium myreth sulfate.

Example for the enzymes are, but not limited thereto, proteases, amylases, lipase, cellulases, mannanases, and pectinases.

Here, the at least one cleaning agent is a chemical compound, which is adapted to remove ink from the substrate in a “chemical” manner e.g., by dissolving, emulsifying, complexing, and/or dispensing the ink of the substrate. The addition of at least one of the above cleaning agents allows a very effective cleaning of the front side of the substrate. Moreover, two types of cleaning procedures may be carried out by one single cleaning unit. On the one side, the cleaning element is adapted to remove the ink in an “abrasive” manner from the front side of the substrate, whereas on the other side the at least one cleaning agent enables a “chemical” cleaning of the substrate.

For example, the at least one cleaning agent may be dispensed or dissolved in the organic and/or aqueous solution of the detergent.

Preferably, at least one base is dissolved in the detergent. More preferably, at least one base is dissolved in an aqueous solution of the detergent.

A suitable example may be an aqueous solution of potassium hydroxide.

According to another aspect of the invention, the at least one cleaning unit is arranged adjacent to the at least one printing unit in the substrate transport system, in particular, the cleaning unit is arranged in-between two printing units along the printing handling path.

Selecting the above location for mounting the cleaning units in the substrate transport system is preferred, since this part of the machine provides sufficient space for arranging and mounting the cleaning units. Hence, it is not necessary to install additional space solely for the cleaning unit.

In another aspect of the invention, the rotary printing press further comprises at least one drying unit which is assigned to the printing handling path, wherein the at least one drying unit is arranged between the unwinder station and the at least one printing unit along the printing handling path. Further, the at least one drying unit is adapted to direct the stream of air onto the front side of the substrate such that the detergent is removed from the front side of the substrate.

With other words, the stream of air which is directed onto the front side of the substrate can either remove the detergent from the front side by force of the stream and/or evaporate the detergent on the front side of the substrate. In a typical rotary printing press, the drying units are anyway pre-mounted to dry the applied ink during the printing process. Thus, the drying units can be used in an synergistic way for removing the detergent.

The invention further relates to a method for cleaning a substrate in a substrate transport system of a rotary printing press. The method comprises the following steps:
a) Switching the substrate transport system in a stationary mode such that the transport of the substrate from the unwinder station to the winder station is stopped,
b) Switching the substrate transport system in a reverse mode such that the substrate is transported reversely from the winder station to the unwinder station, and
c) Cleaning the substrate during the reverse mode.

The basic idea of the invention is to make use of the different running directions of the substrate along the substrate transport system thereby enabling a cleaning and printing at the same space, namely along the printing handling path. With other words, no special compartment for cleaning the substrate in the rotary printing press machine is required. Instead, the cleaning units are assigned to the printing handling path together with the printing units. As a result, the substrate may be printed while moving along the substrate handling path from the unwinder to the winder station i.e. during the forward mode, while in the reverse mode the substrate is cleaned on its way back to the unwinder station.

Another advantage of the above method is the fact that a cleaning phase comprising the above steps a)-c) is decoupled in time from the adjustment phase in which the substrate is printed. Thus, cleaning of the substrate can be carried out after the actual adjustment phase without interference to said phase.

According to another aspect of the invention, the steps b) and c) and/or during step c) a further step d) is carried out, wherein said step comprises: d) applying at least one detergent onto the front side of the substrate.

With other words, the detergent can be applied prior to the actual cleaning step c). This provides the advantage that the detergent can wet the front side of the substrate before the cleaning unit removes the ink by abrasive means. This may be in particular useful in removing persistent inks i.e. inks having a strong adhesion to the substrate surface.

However, according to the above aspect, the addition of the detergent may be carried out while the substrate is actually cleaned during the reverse mode.

According to another aspect of the invention, the method further comprises a step e):
e) Drying the front side of the substrate such that the detergent is removed from the front side of the substrate.

After cleaning the front side of the substrate by a cleaning unit using abrasive means and the addition of a detergent, said detergent can be easily removed by the use of a drying step e).

Preferably, the cleaning step c) is carried out by brushing and/or wiping the substrate. With other words, the cleaning of the substrate during the reverse mode is carried out by abrasive means.

In the following, the invention will be described in detail with reference to the enclosed drawing, in which

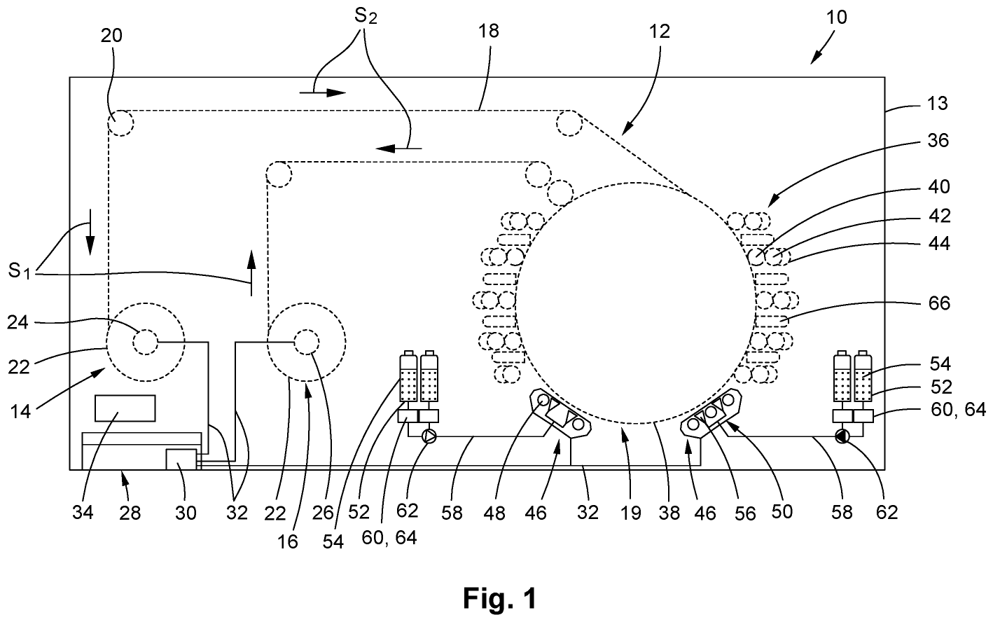

FIG. 1 is a scheme of a rotary printing press with two cleaning units according to the invention.

FIG. 1 depicts a rotary printing press 10 according to the invention.

The rotary printing press 10 comprises a substrate transport system 12, the substrate transport system 12 being accommodated within a housing 13 of the rotary printing press 10.

In particular, the housing 13 completely encapsulates the substrate transport system 12.

Said substrate transport system 12 comprises a winder station 14 and an unwinder station 16 which are configured to transport a substrate 18 along a printing handling path 19 from the unwinder station 16 to the winder station 14.

In principle, the substrate transport system 12 works as a conveyor road. For transporting the substrate 18 along the printing handling path 19 a plurality of rollers 20 are employed, each roller 20 being adapted to guide the substrate 18 within the housing 13 between unwinder station 16 and winder station 14.

The material of which the substrate 18 is made is not limited and may comprise paper, cardboard, metal foil, plastic and combinations thereof.

As it can be seen from FIG. 1, the substrate 18 has the shape of a tape (web) which extends continuously between unwinder station 16 and winder station 14. At each of said stations 14, 16, the substrate 18 is coiled on a substrate roll 22. At the winder station 14, the substrate roll 22 is carried by a winder cylinder 24 while at the unwinder station 16, the substrate roll 22 is carried by an unwinder cylinder 26.

Further, the rotary printing press 10 comprises a command station 28 to control the rotary printing press 10, particularly the substrate transport system 12.

A control unit 30 is assigned to the command station 28, wherein the control unit 30 is connected to the substrate transport system 12 via an electrical connection 32. In particular, the control unit 30 is connected via two connections 32 to the winder station 14 and the unwinder station 16, respectively.

Further, the control unit 30 is configured to control a speed of the substrate 18 which is moved through the substrate transport system 12 along the printing handling path 19. Therefore, the control unit 30 is particularly adapted to control the rotation speed and rotation direction of the winder cylinder 24 and the unwinder cylinder 26, respectively.

In particular, the command station 28 provides a user interface 34 to allow an operator to manually operate the control unit 30.

However, the control unit 30 may also be adapted to automatically control the rotation speed and rotation direction of the winder cylinder 24 and the unwinder cylinder 26.

The user interface 34 and the control unit 30 may be a monitor and computer, respectively.

The rotary printing press 10 further comprises at least one printing unit 36 which is arranged around the perimeter of a central cylinder 38. In addition, the at least one printing unit 36 is located adjacent to the printing handling path 19 extending circumferentially around the central cylinder 38.

As it can be seen in FIG. 1, there is more than one printing unit 36 arranged around the central cylinder 38. In fact, a plurality of printing units 36 is foreseen, each printing unit 36 providing at least one type of ink for printing the substrate 18.

In detail, each printing unit 36 comprises a plate cylinder 40 which is assigned to the printing handling path 19 surrounding the central cylinder 38. The plate cylinder 40 comprises a flexible relief plate (here not shown), also known as flexo plate, for transferring the ink to the front side of the substrate 18. In detail, the flexo plate extends along the a perimeter of the plate cylinder 40 and is fixedly mounted thereto.

Opposite to the substrate handling path 19, the flexo plate is contacted by an anilox cylinder 42, wherein the anilox cylinder 42 receives ink from an ink tray 44. The ink tray 44 is further known as a doctor blade assembly.

In fact, the plate cylinder 40, the anilox cylinder 42 and the ink tray 44 are forming one printing unit 36.

The rotary printing press 10 further comprises at least one cleaning unit 46 which is assigned to the printing handling path 19 and adapted to remove ink from the front side of the substrate 18.

The at least one cleaning unit 46 comprises one or more cleaning elements 48 selected from the group consisting of brushes, brush rollers and mitter curtains and combinations thereof.

In given FIG. 1, there are in total two cleaning units 46, each cleaning unit comprising three cleaning elements 48.

However, the above number of cleaning units 46 is just exemplary. In principle, there may also be one single printing unit 46 or three or more cleaning units 46 used.

The cleaning unit 46 further comprises a dispenser unit 50, the detergent dispenser unit 50 comprising at least one detergent reservoir 52, the detergent reservoir 52 including at least one detergent 54, and at least one nozzle 56, wherein the detergent reservoir 52 and the nozzle 56 are fluidly coupled to each other via a pipe 58.

The detergent reservoir 48 is configured to supply the detergent 54 to the nozzle 56. Therefore, a pump 60 is assigned to the dispenser unit 50. Preferably, the pump 60 is assigned to the pipe 58 between the detergent reservoir 52 and the cleaning unit 46.

The nozzle 56 is adapted to apply detergent 54 onto the front side of the substrate 18 and/or the cleaning element 48.

Preferably, the nozzle 56 may be a jet nozzle, a high velocity nozzle or a spray nozzle.

Between the detergent reservoir 52 and the cleaning unit 46 a valve 62 may be arranged. The valve 62 controls the amount of detergent 54 which is released from the detergent reservoir 52. Furthermore, the valve 62 is adapted to select between different detergents 54, if more than one detergent reservoir 52 is foreseen. In this case, the valve 62 may be a three-way valve.

In addition, a heating unit 64 is assigned to the at least one detergent reservoir 52 and which is adapted to heat the detergent 54 to the predetermined temperature.

Preferably, the heating unit 64 heats up the detergent 54 to a temperature above room temperature, which means more than 25° C. More preferably, the predetermined temperature is at least 35° C.

The detergent dispenser unit 50 may comprise more than one detergent reservoir 52. As can be seen from FIG. 1, there are in total two reservoirs 52 per one cleaning unit 46. Preferably, each reservoir 52 includes at least one detergent 54 which is different from the at least one detergent 54 of the other detergent reservoir 52.

The at least one detergent 54 comprises an organic and/or an aqueous solution.

The at least one detergent further comprises at least one cleaning agent, wherein the at least one cleaning agent is selected from the group consisting of base, acid, surfactant, enzyme, zeolite and additive and a combination thereof.

Most preferably, the detergent used is an aqueous solution of potassium hydroxide.

Furthermore, a drying unit 66 is assigned to the printing handling path 19. In particular, the drying unit 66 is arranged between the unwinder station 16 and the winder station 14 along the printing handling path 19. The at least one drying unit 66 is adapted to direct a stream of air onto the front side of the substrate such that the detergent is removed from the front side of the substrate 18.

As it can be seen from FIG. 1, there is a plurality of drying units 66 arranged around the perimeter of the central cylinder 38. In particular, each drying unit 66 is arranged between two printing units 36, wherein each printing unit 36 is arranged between two drying units 66.

The cleaning mechanism for the substrate 18 can be explained as follows.

In the adjustment phase prior to a printing process, the substrate 18 is transported from the unwinder station 16 to the winder station 14, hereinafter defined as direction S1. In order to adjust the printing settings for the subsequent printing process, the substrate 18 is printed by at least one printing unit 36, which means that ink is applied onto the front side of the substrate 18 while said substrate 18 is transported by the substrate transport system 12 around the perimeter of the central cylinder 38.

In particular, images are taken from the substrate 18 and evaluated at the command station 28 for adjusting the printing settings.

In order to clean the substrate 18, the following steps are carried out.

First, the substrate transport system 12 is switched to a stationary mode such that the transport of the substrate 18 from the unwinder station 16 to the winder station 14 along direction S1 is stopped. Preferably, this step is carried out after the parameters for the printing job have been adjusted.

Second, the substrate transport system 12 is switched in a reverse mode such that the substrate 18 is transported reversely from the winder station 14 to the unwinder station 16 along a direction S2. Because of this reverse mode, the substrate which has been printed during the adjustment phase can be recovered from the unwinder station 16 and can be transported back to the winder station 14.

The speed and the direction of transport are controlled by the control unit 30, which controls the rotation speed and rotation direction of the winder cylinder 24 and the unwinder cylinder 26.

Subsequently, the substrate 18 can be cleaned during the reverse mode. This step can be carried out by the at least one cleaning unit 46 with the help of the cleaning element 48 and the dispenser unit 50.

For example, the detergent 54 can be applied onto the front side of the substrate 18. The applied detergent 54 can be brushed or wiped over the front side of the substrate 18 by the at least one cleaning element 48 thereby removing the ink from the substrate.

Preferably, the cleaning element 48 may be a roller brush, a brush and/or a mitter curtain.

Optionally, the detergent 54 is removed from the front side of the substrate 18 by using at least one drying unit 66. The drying unit 66 directs a stream of air onto the front side of the substrate 18 such that the substrate 18 is dried during the reverse mode.

The so cleaned and dried substrate 18 is afterwards collected at the unwinder station 16 and can be used for the actual printing job.

1. A rotary printing press for printing substrates, the rotary printing press comprising:
a substrate transport system which comprises a winder station and an unwinder station configured to transport a substrate during a printing process along a printing handling path from the unwinder station to the winder station,
at least one printing unit arranged between the winder station and the unwinder station and configured to apply an ink to a front side of the substrate being moved through the printing unit along the printing handling path, and
a control unit which is connected to the substrate transport system, wherein said control unit is configured to control a speed of the substrate which is moved through the substrate transport system along the printing handling path,
characterized in that the rotary printing press further comprises at least one cleaning unit which is assigned to the printing handling path and adapted to remove ink from the front side of the substrate.

2. The rotary printing press according to claim 1, wherein the at least one cleaning unit comprises one or more cleaning elements selected from the group consisting of brushes, brush rollers and mitter curtains and combinations thereof.

3. The rotary printing press according to claim 2, wherein the rotary printing press further comprises a detergent dispenser unit, the detergent dispenser unit comprising:
at least one detergent reservoir, said detergent reservoir including at least one detergent, and
at least one nozzle,
wherein the detergent reservoir and the nozzle are fluidly coupled to each other,
wherein the detergent reservoir is configured to supply the detergent to the nozzle, and wherein the nozzle is adapted to apply the detergent onto the front side of the substrate and/or the cleaning element.

4. The rotary printing press according to claim 3, wherein the detergent dispenser unit comprises a heating unit which is assigned to the at least one detergent reservoir and is adapted to heat the detergent to a predetermined temperature.

5. The rotary printing press according to claim 3, wherein the detergent dispenser unit comprises at least two detergent reservoirs, each reservoir includes at least one detergent which is different from at least one detergent of the other detergent reservoir.

6. The rotary printing press according to claim 3, wherein the at least one detergent comprises an organic and/or an aqueous solution.

7. The rotary printing press according to claim 6, wherein the at least one detergent further comprises at least one cleaning agent, wherein the least one cleaning agent is selected from the group consisting of base, acid, surfactants, enzymes, zeolites and additives and combinations thereof.

8. The rotary printing press according to claim 1, wherein in the substrate transport system the cleaning unit is arranged adjacent to the at least one printing unit, in particular, the cleaning unit is arranged in between two printing units along the printing handling path.

9. The rotary printing press according to claim 1, wherein the rotary printing press further comprises at least one drying unit which is assigned to the printing handling path,
wherein the least one drying unit is arranged between the unwinder station and the at least one printing unit along the printing handling path, and
wherein the at least one drying unit is adapted to direct a stream of air onto the front side of the substrate such that detergent is removed from the front side of the substrate.

10. A method for cleaning a substrate in a substrate transport system of the rotary printing press according to claim 1, wherein the method comprises the following steps:
a) switching the substrate transport system in a stationary mode such that the transport of the substrate from the unwinder station to the winder station is stopped,
b) switching the substrate transport system in a reverse mode such that the substrate is transported reversely from the winder station to the unwinder station, and
c) cleaning the substrate during the reverse mode.

11. The method according to claim 10, wherein between steps b) and c) and/or during step c) a further step d) is carried out:
d) applying at least one detergent onto the front side of the substrate.

12. The method according to claim 11, wherein the method further comprises a step e):
e) Drying the front side of the substrate such that the detergent is removed from the front side of the substrate.

13. The method according to claim 10, wherein the cleaning step c) is carried out by brushing and/or wiping the substrate.
